(19) United States
(12) Patent Application Publication
(10) Pub. No.: US 2012/0278202 A1
(43) Pub. Date: Nov. 1, 2012

(54) VIRTUAL PIGGYBANK HAVING QUICK CONNECT

(75) Inventors: Jo Webber, Philadelphia, PA (US); Pradeep Ittycheria, Philadelphia, PA (US)

(73) Assignee: Virtual Piggy, Inc., Philadelphia, PA (US)

(21) Appl. No.: 13/431,044

(22) Filed: Mar. 27, 2012

Related U.S. Application Data
(60) Provisional application No. 61/479,243, filed on Apr. 26, 2011.

(51) Int. Cl. G06Q 30/06; G06Q 30/00

(52) U.S. Cl. 705/26.41; 705/39

(57) ABSTRACT

A computer-implemented method of establishing an online account for a prospective user, comprising the steps of presenting to a first user a merchant system through a network; receiving from the first user a product selected from the merchant system for purchase; presenting an online account icon for a banking system to the first user to initiate payment for the selected product; once the icon is selected by the first user, determining if the user has an account with the banking system, and if not, prompting the first user to enter a second user's contact information; contacting the second user by electronic messaging with a request to approve the first user's purchase; and upon receiving the approval, creating the online account for the first user.

This application claims the priority and benefit of U.S. Provisional Patent Application No. 61/479,243, filed on Apr. 26, 2011, which is incorporated herein by reference.

### CROSS-REFERENCE TO RELATED APPLICATIONS

This application is related to U.S. patent application Ser. No. 12/991,063 filed Apr. 8, 2011, which claims the priority and benefit of U.S. Provisional Patent Application No. 61/272,235 filed on Sep. 3, 2009, and is incorporated herein by reference.

This application is related to U.S. patent application Ser. No. 12/991,053 filed Apr. 8, 2011, which claims the priority and benefit of U.S. Provisional Patent Application No. 61/272,233 filed on Sep. 3, 2009, and is incorporated herein by reference.

This application is related to U.S. patent application Ser. No. 12/991,057 filed Apr. 8, 2011, which claims the priority and benefit of U.S. Provisional Patent Application No. 61/272,234 filed on Sep. 3, 2009, and is incorporated herein by reference.

This application is related to U.S. patent application Ser. No. 12/991,059 filed Apr. 8, 2011, which claims the priority and benefit of U.S. Provisional Patent Application No. 61/272,232 filed on Sep. 3, 2009, and is incorporated herein by reference.

### BACKGROUND OF THE INVENTION

1. Field of the Invention

The present invention relates an Internet payment system and method, and more particularly to an Internet payment system and method having a variety of customizable controls, which can be accessed and implemented during an actual purchasing transaction.

2. Discussion of the Related Art

Using the Internet has become extremely easy, and one aspect of this ease is that children of very young ages are able to gain access to Internet websites of all kinds and make purchases at a variety of websites. Juxtaposed with this ease is the Children's Online Privacy Protection Act (COPPA), which lays out specific guidelines for how website operators and online businesses must interact with children 13 and under. In general COPPA requires parental notification and consent prior to an online operator's collecting, using or disclosing a child's personal information. Compliance with COPPA can be daunting for an online business. While some online businesses are taking steps to comply with COPPA, many of the new media companies including Facebook are choosing to avoid COPPA compliance by restricting their sites to over 13's, and foregoing a significant business opportunity in interacting with the under 13 market segment. In the past, parents were often happy to give their children small amounts of money to buy comics and candy from a corner store, there is no equivalent mechanism currently for the internet. The generation of children growing up today has never known a world where the internet was not present and they expect to be able to play games, interact with friends and make purchases online. There is ever increasing pressure on the parents and guardians to provide more online access to their children, while at the same time a worrying lack of control in the online world.

Parental controls are known and generally fall into two categories: active control and passive control. Active controls (e.g., hardware and software firewalls; and hardware access controls and systems) prevent a child from accessing information over the Internet that a parent does not want them to retrieve and view. Passive controls (e.g., a software audit system) allow a parent to audit the information their children have been accessing and the activities their children have been performing while online. While these active and passive control systems help parents to control the information available to children via the Internet, there are no provisions to control the types of services that children may sign up for and/or purchase over the Internet.

Currently, parents may either provide their children with a credit card or purchase a pre-paid card so that their children may conduct a monetary transaction on the Internet. While this may work for a few instances, it is not a viable option with the rapid growth of websites, online games and online applications appealing to children and the ever increasing online footprint of children. The credit card is also particularly troubling since it provides no control or limitation on what or how much the child can acquire.

With the rapid proliferation of websites, online games, and online applications for children under 13, there is a need for a system that parents can setup and children can use to conduct online monetary transactions while limiting or obviating a child's need to provide their personal information. Thus, a system is needed that will enable a parent to quickly and easily manage a child's access and personal information provided to websites, or in the alternative provide parental consent to the collection and use of certain necessary information as well as to control how money is spent at the websites by a child.

### SUMMARY OF THE INVENTION

Accordingly, the present invention is directed to a system and method for a virtual piggybank that substantially obviates one or more problems due to limitations and disadvantages of the related art.

An embodiment of the present invention provides an improved Internet payment method and system that may be accessed during an actual purchasing transaction.

Another embodiment of the present invention provides an Internet payment method and system that may be used by a child at online websites, games, and applications that can immediately be approved by a parent.

Yet another embodiment of the present invention provides an Internet payment method and system that enables a parent to immediately manage a child's access to websites and control how money is spent at the websites by a child.

Yet another embodiment of the present invention provides an Internet payment method and system that may be used by any user at online websites with certain controls and payment procedures that can be set up at the website quickly and easily.

Additional features and advantages of the invention will be set forth in the description which follows, and in part will be apparent from the description, or may be learned by practice of the invention. The advantages of the invention will be realized and attained by the structure particularly pointed out in the written description and claims hereof as well as the appended drawings.

To achieve these and other advantages and in accordance with the purpose of the present invention, as embodied and broadly described, in one aspect, a computer-implemented method of establishing an online account for a prospective user, the method comprising the steps of: presenting to a first user a merchant system through a network; receiving from the first user a product selected from the merchant system for purchase; presenting an online account icon for a banking system to the first user to initiate payment for the selected product; once the icon is selected by the first user, determining if the user has an account with the banking system, and if not, prompting the first user to enter a second user's contact information; contacting the second user by electronic messaging with a request to approve the first user's purchase; and upon receiving the approval, creating the online account for the first user.

In another aspect, the system for virtual piggybank includes a system for establishing an online account for a prospective user, the system comprising: a server connected to the Internet; a client's Internet activated device; a database hosted on the server, the database storing information for a money management system and for a virtual bank to facilitate payment to merchants over the Internet; and web based systems, web services, and Internet enabled desktop applications partner with the virtual bank to create the online account for the first user.

In yet another aspect, the instructions for virtual piggybank includes a computer-readable storage medium, storing one or more programs configured for execution, the one or more programs for monitoring, transmitting, and recording usage of a computer or mobile device connected to a network, the one or more programs comprising instructions to: presenting to a first user a partner merchant system through a network; receiving from the first user a product selected from the partner merchant system for purchase; presenting an online account icon for a banking system to the first user to initiate payment for the selected product; once the icon is selected by the first user, determining if the user has an account with the banking system, and if not, prompting the first user to enter a second user's contact information; contacting the second user by electronic messaging with a request to approve the first user's purchase; and upon receiving the approval, creating the online account for the first user.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates an example of a local area network (LAN) 100 that is connected to the Internet and in which the inventive method may be utilized;

FIG. 2 illustrates the TCP/IP Layering Model;

FIG. 3 illustrates a virtual piggybank system according to an exemplary embodiment of the present invention;

FIG. 4 is a flow chart illustrating a method for implementing a virtual piggybank according to an exemplary embodiment of the present invention;

FIG. 5 is a flow chart illustrating a method for authorizing a contributor according to an exemplary embodiment of the present invention;

FIG. 6 is an exemplary screen shot of the preferences setup according to an exemplary embodiment of the present invention;

FIG. 7 is an exemplary monthly spending report according to an exemplary embodiment of the present invention;

FIG. 8 is a flow chart illustrating a method for implementing the spending functionality of virtual piggybank system according to an exemplary embodiment of the present invention;

FIG. 9 illustrates an exemplary application of the virtual piggybank system according to an exemplary embodiment of the present invention; and

FIG. 10 illustrates exemplary preferences of an add child profile screen according to an exemplary embodiment of the present invention.

FIG. 11 is a flow chart illustrating how the short cut to sign on for the system is implemented.

FIG. 12 is a flow chart illustrating how to implement a short cut payment using a credit card.

FIG. 13 is a flow chart illustrating how to implement a short cut payment using a mobile payment option.

### DETAILED DESCRIPTION OF THE EXEMPLARY EMBODIMENTS

Reference will now be made in detail to the embodiments of the present invention, examples of which are illustrated in the accompanying drawings.

In the following detailed description, numerous non-limiting specific details are set forth in order to assist in understanding the subject matter presented herein. It will be apparent, however, to one of ordinary skill in the art that various alternatives may be used without departing from the scope of the present invention and the subject matter may be practiced without these specific details. For example, it will be apparent to one of ordinary skill in the art that the subject matter presented herein can be implemented by any type of user (i.e., not limited to parent and child) and on any type of standalone system or client-server compatible system containing any type of client, network, server, and database elements.

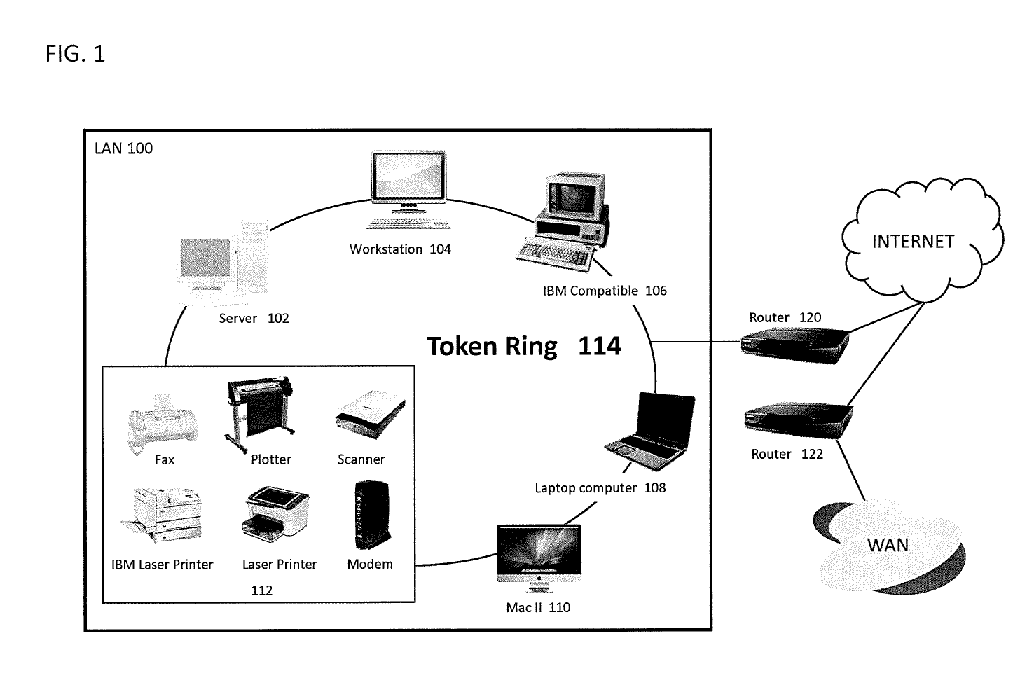

FIG. 1 illustrates an example of a local area network (LAN) 100 that is connected to the Internet and in which the inventive system and method may be utilized. LAN 100 comprises a server 102, four computer systems 104, 106, 108, 110, and peripherals, such as printers and other devices 112, that may be shared by components on LAN 100. Computer systems 104, 106, 108, 110 may serve as clients for server 102 and/or as clients and/or servers for each other and/or for other components connected to LAN 100. Components on LAN 100 are preferably connected together by cable media, for example, unshielded twisted pair (UTP) Category 5 copper cable, and the network topology may be an Ethernet topology 114. It should be apparent to those of ordinary skill in the art that other media, for example, fiber optic or wireless radio frequency media, may also connect LAN 100 components. It should also be apparent that other network topologies, such as Token Ring, may be used.

Data may be transferred between components on LAN 100 in packets, i.e., blocks of data that are individually transmitted over LAN 100. Routers 120, 122 create an expanded network by connecting LAN 100 to other computer networks, such as the Internet, other LANs or Wide Area Networks (WAN). Routers are hardware devices that may include a conventional processor, memory, and separate I/O interface for each network to which it connects. Hence, components on the expanded network may share information and services with each other. In order for communications to occur between components of physically connected networks, all components on the expanded network and routers that connect them must adhere to a standard protocol. Computer networks connected to the Internet and to other networks typically use TCP/IP Layering Model Protocol. It should be noted that other internetworking protocols may be used.

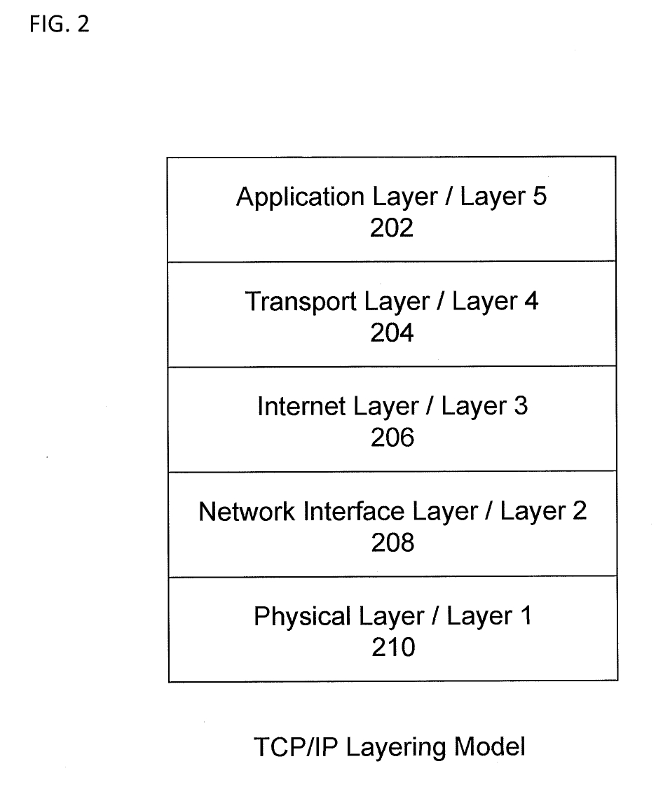

FIG. 2 illustrates the TCP/IP Layering Model, which is comprised of an application layer (Layer 5) 202, a transport layer (Layer 4) 204, an Internet layer (Layer 3) 206, a network interface layer (Layer 2) 208, and a physical layer (Layer 1) 210. Application layer protocols 202 specify how each software application connected to the network uses the network. Transport layer protocols 204 specify how to ensure reliable transfer among complex protocols. Internet layer protocols 206 specify the format of packets sent across the network as well as mechanisms used to forward packets from a computer through one or more routers to a final destination. Network interface layer protocols 208 specify how to organize data into frames and how a computer transmits frames over the network. Physical layer protocols 210 correspond to the basic network hardware. By using TCP/IP Layering model protocols, any component connected to the network can communicate with any other component connected directly or indirectly to one of the attached networks.

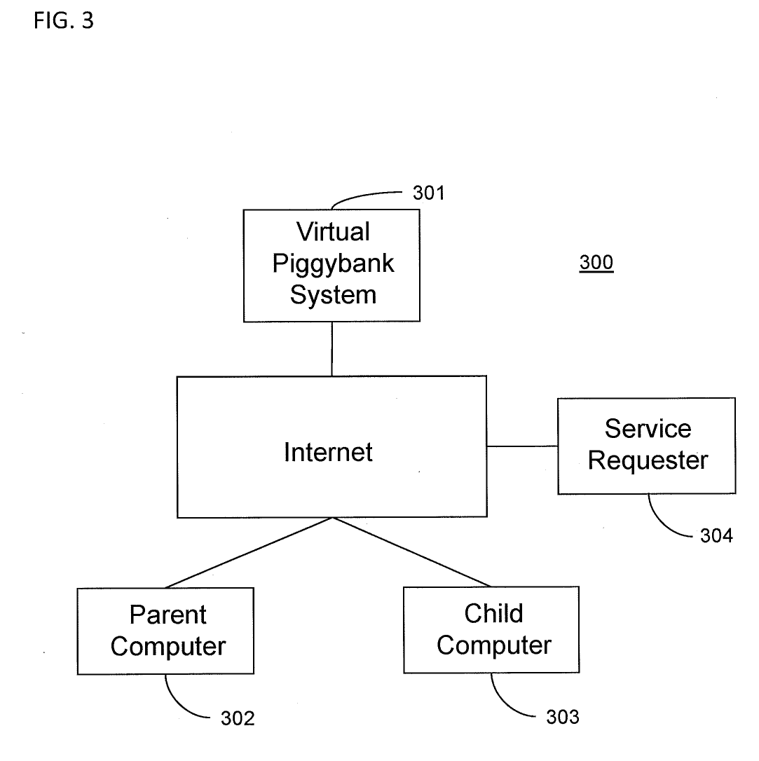

FIG. 3 illustrates a virtual piggybank system according to an exemplary embodiment of the present invention.

As shown in FIG. 3, the virtual piggybank system 300 includes a virtual piggybank server 301, parent computer 302, child computer 303, and service requester 304. The virtual piggybank server 301 may include a persistent software system and service that allow one or more persons responsible for one or more children to establish a controlled money management and payment system for use over the Internet. The adult preferences are stored on a database, and include parental/guardian preferences and controls for the money management. The system provides an Application Programming Interface (API) that exposes software functions that other websites, web services and Internet enabled desktop applications can use to enforce the adult preferences when children try to purchase items online. The websites, web services and Internet enabled desktop applications partner with the present system (“virtual piggybank”), and an account is created. Each of the parent computer 302 and child computer 303 may be a desktop computer, laptop computer, tablet or portable computer, smartphone, mobile phone, or other portable computing device. Service requester 304 may include any online application such as websites, online stores, online games, and online applications.

The following description uses as an example a parent as the person desiring to set controls regarding Internet use and a child as being the Internet user who will be controlled. These are only examples, and the invention is not limited to those two classes of people. For example, the following description would be equally applicable to an employer and employee.

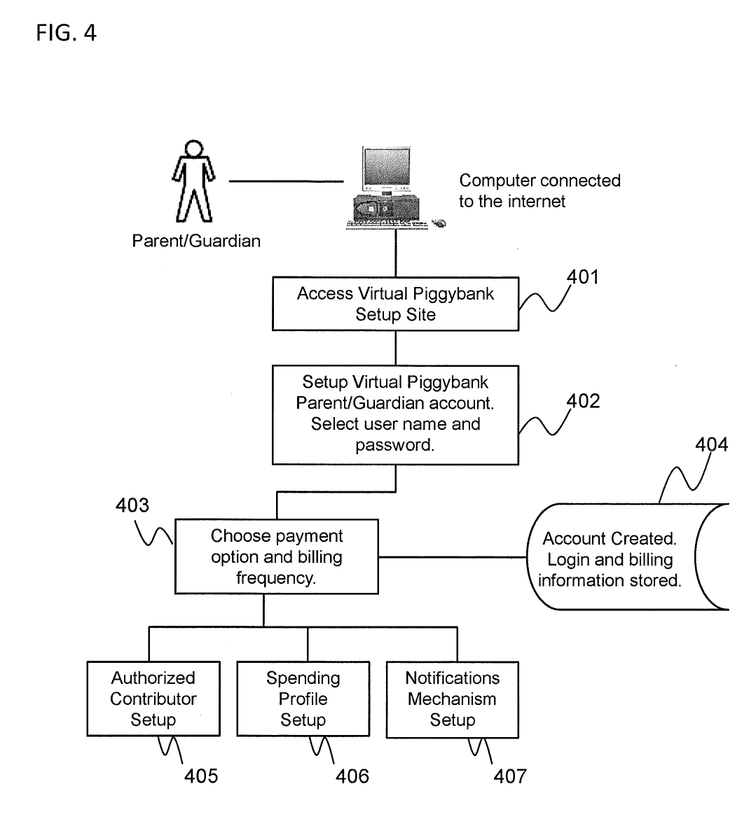

FIG. 4 is a flow chart illustrating a method for implementing a virtual piggybank according to a first exemplary embodiment of the present invention.

At step 401, a parent accesses the virtual piggybank system via the Internet to establish a virtual piggybank for a child. For example, the virtual piggybank may be an Internet bank account for use by a child, but the virtual piggybank is not limited to this example. In order to establish a virtual piggybank for a child, a parent may first establish a parental account.

At step 402, a parent may establish a parental account. The virtual piggybank system may guide the parent through the set up of a parental account. To establish a parental account, a parent profile is created. A parent profile allows a parent to provide information that allows the virtual piggybank system to interact with a parent. For example, the virtual piggybank system may support OpenID. A parent may be able to use an OpenID account to establish a parent profile. However, the virtual piggybank system may request additional information as well, such as a password, name (first, middle and last), address information, verification preference such as e-mail or short message service (SMS) that is used to verify a parental account, primary phone number, mobile phone number that may be used if SMS is selected as a verification preference so that SMS messages may be sent to a mobile phone, a primary e-mail address that may be used if e-mail selected as verification preference, secondary e-mail, password reminder questions, time-zone such that dates and times in the virtual piggybank system are based on this time-zone and not the time-zone of the server, and currency preferences.

The parental account is secure and can only be accessed with the correct user name and password. All data transmissions may be encrypted and secure, such as all profile information. Passwords that may be used by the parent, child or others designated to properly use the system may have expiration dates to insure password strength. After a parental account is established, a parent may then establish one or more child accounts. The settings of a child account may then be controlled by the parental account. For example, the virtual piggybank system may present a number of options from which a parent may choose such that various controls may be imposed on a child by the virtual piggybank.

At step 403, the virtual piggybank system has the parent choose a payment option and/or billing frequency. For example, charges made to a child account may be applied to a credit card, debit card, other bank account, or may be billed to a parent on a periodic basis. This information also will be secured through encryption and passwords

A parent may establish one or more payment accounts. A payment account is the account that will be used to make payment for purchases made by a child via a child account. For example, a PayPal or Google payment account may be supported by the virtual piggybank system. Of course, the payment account may be any known to those skilled in the art. The parent may provide a user name and password associated with a payment account so that payments from a child account may be charged to the payment account. The virtual piggybank system may verify the validity of the account using the adaptive account API for Authentication. A parent may provide the following information relating to a payment account: a) payment account name; b) payment account user name and password; c) payment account billing address (e.g., street number, street name, city, state, zip, country); and d) whether to accept outside payments to determine if someone else can fund this account. The last option will be discussed later.

At step 404 a parental account is created. In addition, one or more child accounts also may be created at this time. Account information, such as a user name, password, or payment information may be stored in a secure database by the virtual piggybank server.

To establish a child account, a child profile is created. A child profile may include a user name, password, and payment method, such as a payment account. A child may use the user name and password to conduct transactions on websites, online games and online applications that are approved by a parent through the virtual piggybank system.

Also, a child may add items to a wish-list, and a parent may review and approve items on a child's wish-list. A parent may either buy or remove an item from a child's wish-list. The wish-list may be customized For examples, items in a wish-list may expire and be removed from the wish-list based on the settings of the wish-list.

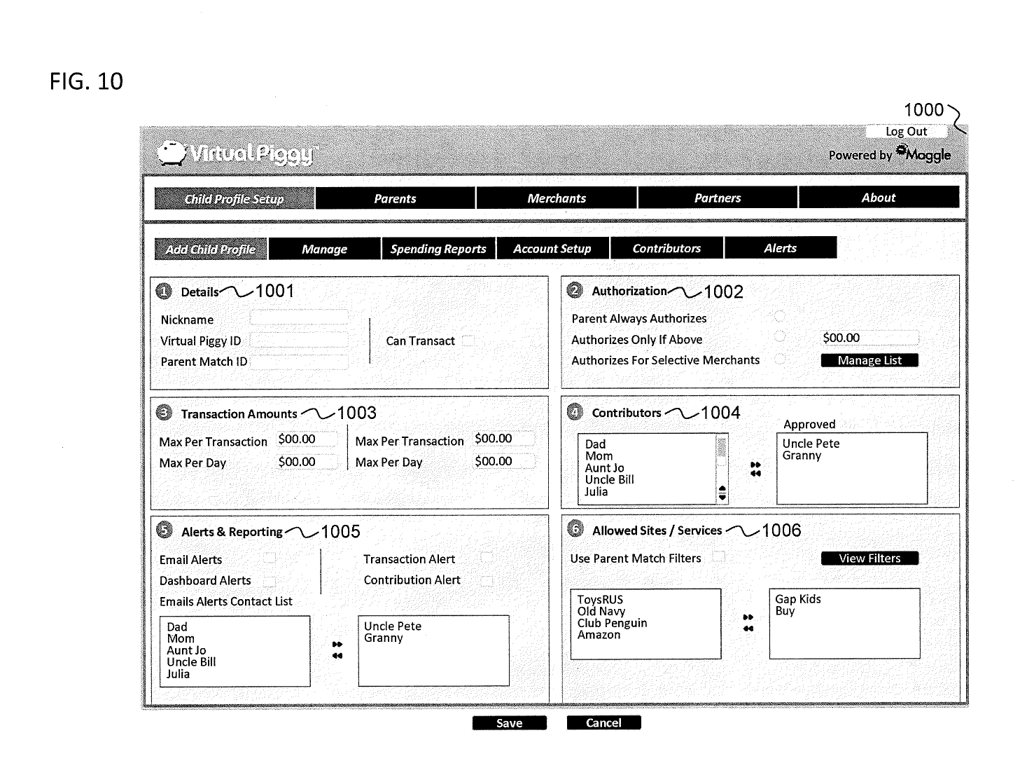

Referring to FIG. 10, illustrated are exemplary preferences of an add child profile screen according to an exemplary embodiment of the present invention.

As shown in FIG. 10, the add profile screen 1000 may be divided into several exemplary screen portions 1001-1006. At screen portion, 1001 a parent may identify a child by name or nickname. Also, a child may be given a child account user name (i.e., Virtual Piggy ID) that is associated with a parent account user name (i.e., Parent Match ID).

At screen portion 1002, a parent may authorize service requesters, including websites and other Internet based applications that a child may visit, from which a child may make purchases, etc. A parent can control whether every service requester needs to be approved by a parent. The parent can also selectively define which service requesters need to be approved while other services may be automatically approved.

At screen portion 1003, a parent may approve transactions from the child account based on a spending amount. A spending limit that limits the amount of money that a child can spend without obtaining parental approval, or a periodic spending limit that limits the amount of money a child can spend on a periodic basis such as, per day, per week, per month, or over any particular time limit. Alternatively, a parent may set a spending limit that limits the amount of money a child can spend on an occasional basis, such as a child's birthday or other holiday. In another alternative, a parent may specify a payment account balance limit such that if the linked payment account balance goes below a specified balance, no additional transactions will be permitted from a child account linked to it.

At screen portion 1004, a parent may designate contributors to a child account. For example, a contributor may be another parent, grandparent, aunt, uncle, or other adult responsible for a child. At screen portion 1005, a parent may specify that notifications be sent for information including alerts regarding transactions, contributions, and a dashboard for the child account. Notifications may be sent by e-mail, SMS, voicemail, or the like. In addition, a parent may specify that notifications be sent to a contributor. At screen portion 1006, a parent may authorize certain service requesters for use by a child.

Referring back to FIG. 4, at step 405, the virtual piggybank system may allow the parent to designate one or more contributors to a child account. A contributor may be a person other than a parent who may add money into the virtual piggybank. For example, a grandparent, uncle, aunt, or other close family member may be designated as a contributor. The virtual piggybank system may allow a parent to impose one or more controls on a contributor. For example, a parent may designate a money limit that a contributor may add to a child account. Such a money limit may be determined by the total amount of money that is presently available to a child in a child account. Alternatively, a money limit may be applied per contributor. In addition, a parent may limit the frequency with which a contributor may add money to a child account.

For example, a parent may designate a person as a contributor by providing that person's name and e-mail address to the virtual piggybank system. The virtual piggybank system may send an e-mail along with an authentication code and a link to a contributor. This link may not expire so that a contributor person can bookmark this page to send repeatedly money when he/she wants. A contributor may then go to the link in the e-mail, enter the code, the validity of which is then determined, and if the code is valid then a contributor may be presented with a form that will allow them to enter their credit card information or payment account information, such as a PayPal or Google account.

At step 406, the virtual piggybank may allow a parent to setup a child profile. The virtual piggybank system may allow a parent to impose one or more controls on a child by setting up a child profile. A child profile may include a list of approved websites (i.e., Service Requester of FIGS. 3, 8, and 10) where a child is authorized to spend money from a child account, a spending limit that limits the amount of money that a child can spend without obtaining parental approval, or a periodic spending limit that limits the amount of money a child can spend on a periodic basis such as per day, per week, per month, or over any particular time limit. Alternatively, a parent may set a spending limit that limits the amount of money a child can spend on an occasional basis, such as a child's birthday or other holiday. In another alternative, a parent may specify a payment account balance limit such that if the linked payment account balance goes below a specified balance, no additional transactions will be permitted from a child account linked to it.

In addition, the virtual piggybank also may allow a parent to specify a time period during which a child may spend money from a child account. For example, a time period may be certain hours of the day, certain days of the week, or any period so desired.

At step 407, the virtual piggybank system may allow a parent to setup specific notifications. Notifications may be sent by e-mail, SMS, voicemail, or the like. Such notifications may include any information regarding the account, such as funds, usage, etc. For example, a parent or contributor may receive notifications concerning the amount of money available to a child or recent purchases of a child, if more than a certain number of transactions are carried out at a particular merchant or by a child over the course of a day, if suspicious behavior occurs (such as a number of unsuccessful login attempts or simultaneous login attempts were made). In another example, a parent or contributor may receive a notification requesting approval of a particular transaction of the child account. In this example, a reply SMS message or e-mail may be sent by a parent or contributor to approve a transaction. Alternatively, the virtual piggybank system may provide one or more links that may be clicked upon to approve or decline a particular transaction. If a notification is provided by phone, a request for approval may be requested after the recital of an automated message, and approval may be solicited through key selection.

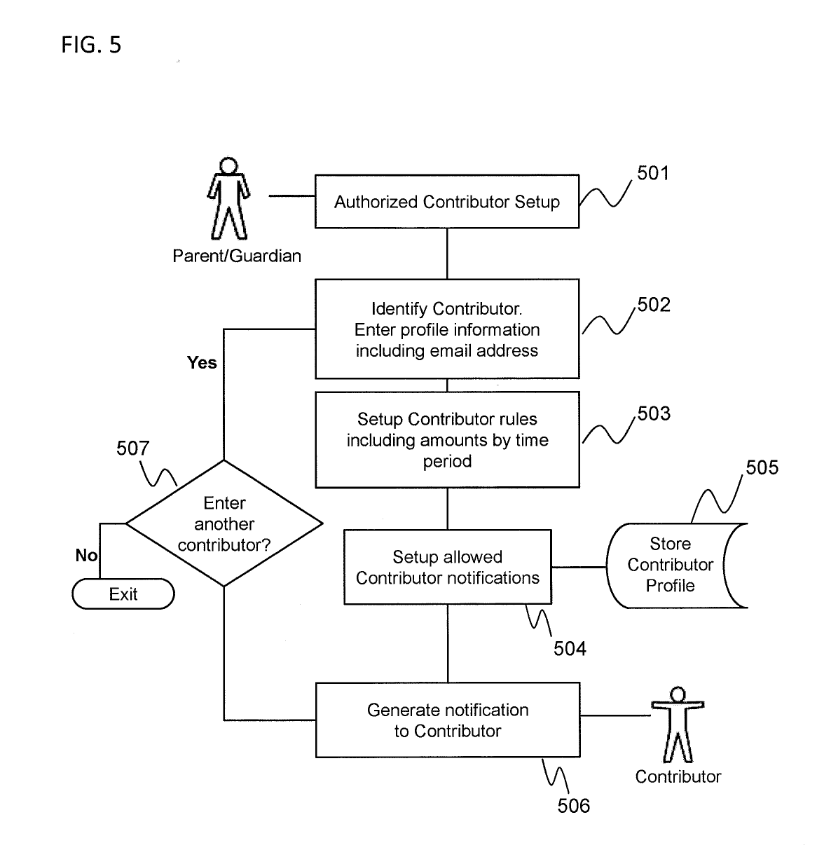

FIG. 5 is a flow chart illustrating a method for authorizing a contributor according to an exemplary embodiment of the present invention.

At step 501, a parent accesses the virtual piggybank system and selects an option to change the Authorized Contributor Setup. As discussed above, a contributor may be a person other than a parent who may add money into a child account of the virtual piggybank system. The virtual piggybank system may allow the parent to designate one or more contributors to a child account.

At step 502, a parent enters profile information for a contributor that that will be authorized by a parent to contribute funds to a child's account in the virtual piggybank. The profile information may include the contributor's name, address, email address, and any other information that will uniquely identify the contributor.

At step 503, the virtual piggybank system may allow a parent to impose one or more controls on a contributor. A parent is presented with a variety of controls that may be applied to a contributor regarding contributions that may be made to a child account. For example, a parent may designate a money limit that limits the amount of money a contributor may add to a child account. Such a money limit may be determined by the total amount of money that is presently available to a child account. Alternatively, a money limit may be applied per contributor. In addition, a parent may limit the frequency with which a contributor may add money to a child account.

At step 504, the virtual piggybank system may allow a parent to set specific notifications to be sent to a contributor. Such notifications may include any information regarding a child account, such as funds, usage, etc.

At step 505, profile information for a contributor is stored in a secure database by the virtual piggybank system. Account information such as a user name, password, or payment information, and notification sending information may be stored in a secure database by the virtual piggybank system.

At step 506, a parent then selects a notification mechanism that the virtual bank sends to the contributor. For example, a notification may be sent by e-mail, SMS, or voicemail. Of course, notifications also may be sent to a parent.

At step 507, a parent is given the option of adding additional contributors. If a parent desires to add an additional contributor, a parent again enters profile information for a contributor at step 502, and again proceeds through the steps outlined above.

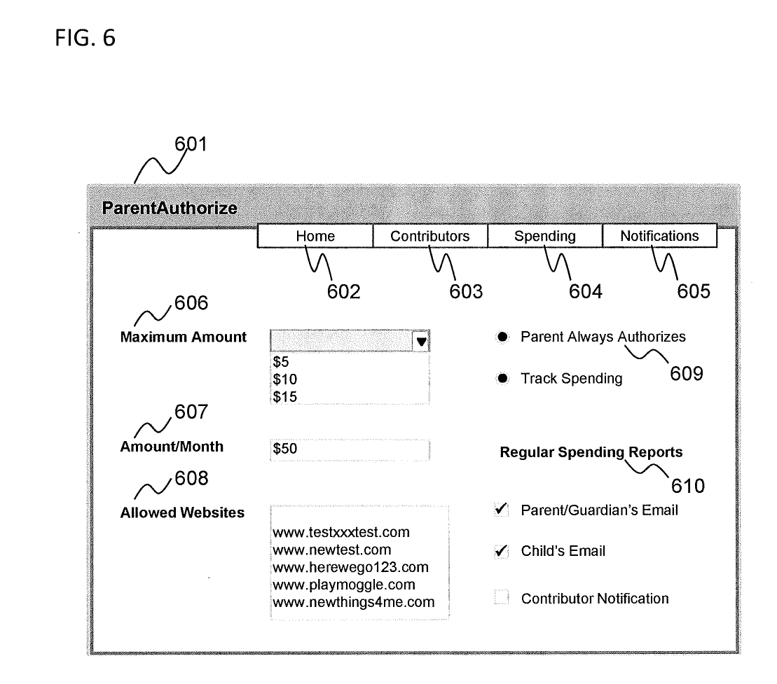

FIG. 6 is an exemplary screen shot of the preferences setup according to an exemplary embodiment of the present invention. Virtual piggybank may be implemented as a secure website a parent sees when setting up the preferences. Parent window 601 illustrates the main parental authorized information, which may include a Home tab 602, Contributors tab 603, Spending tab 604 and Notifications tab 605. The Home tab 602 may contain the general preferences for the parent, including basic contact information for the parent; email, fax, phone, etc. The Contributors tab 603 may hold preferences associated with the authorized contributors. The Spending tab 604 may contain information and preferences related to a child's allowed spending capabilities. This information may include, but is not limited to the maximum amount in a single transaction 606, total spending amount per month 607, websites on which the child may spend funds from the virtual piggybank 608, preferences around parental authorization (e.g., all purchases, purchases over a certain amount, purchases of certain types of product) 609, and preferences around who receives reports and notifications of child's actual spending 610 and frequency of reports.

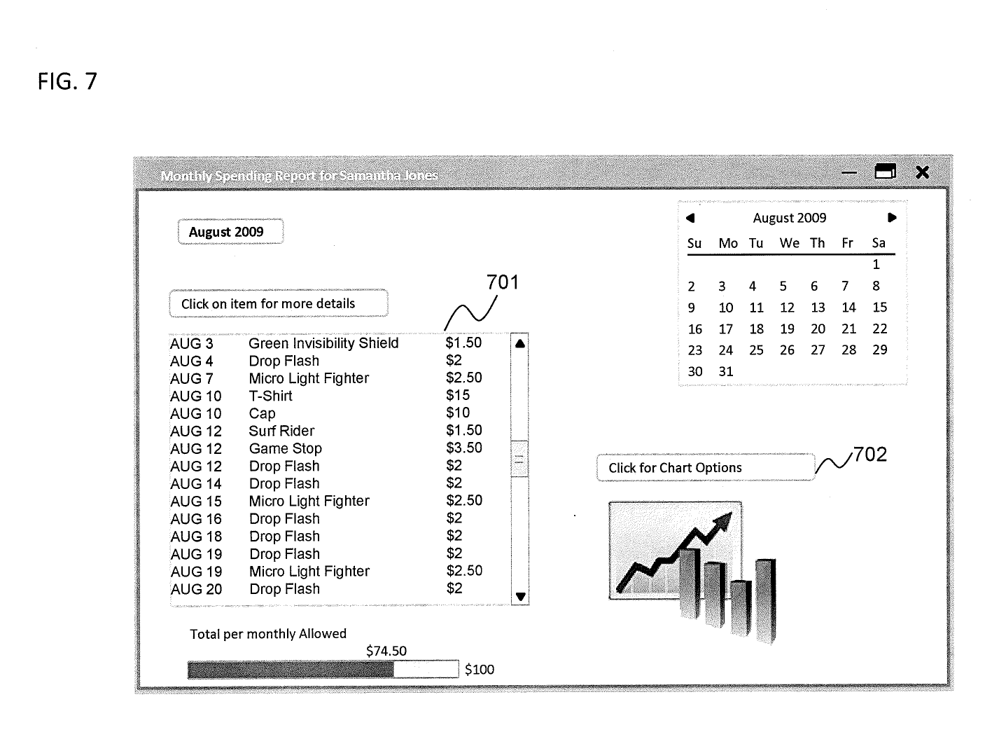

FIG. 7 is an exemplary monthly spending report according to an exemplary embodiment of the present invention. The monthly report may contain information about the child's spending patterns 701 including an itemized list of all purchased items with the ability to drill down and get further details on the item. Further details would show information, such as the website from which the item was purchased, the total amount spent on that website to date, the time of purchase, etc. A parent may be able to see a child's spending patterns compared to prior months and compared to the total monthly spend allowed. A parent may also be able to chart the child's spending data 702, and in the case of a multi-child family, the parent will be able to compare the profiles of all of their children.

A parent may view a spending report by logging into the virtual piggybank system. A spending report may be an onscreen report that a parent can print or e-mail if desired. A spending report is customizable, and may show any combination of transaction dates, transaction amounts, service requesters, daily, weekly and monthly sub-totals. For example, a spending report may be generated for a particular service requester.

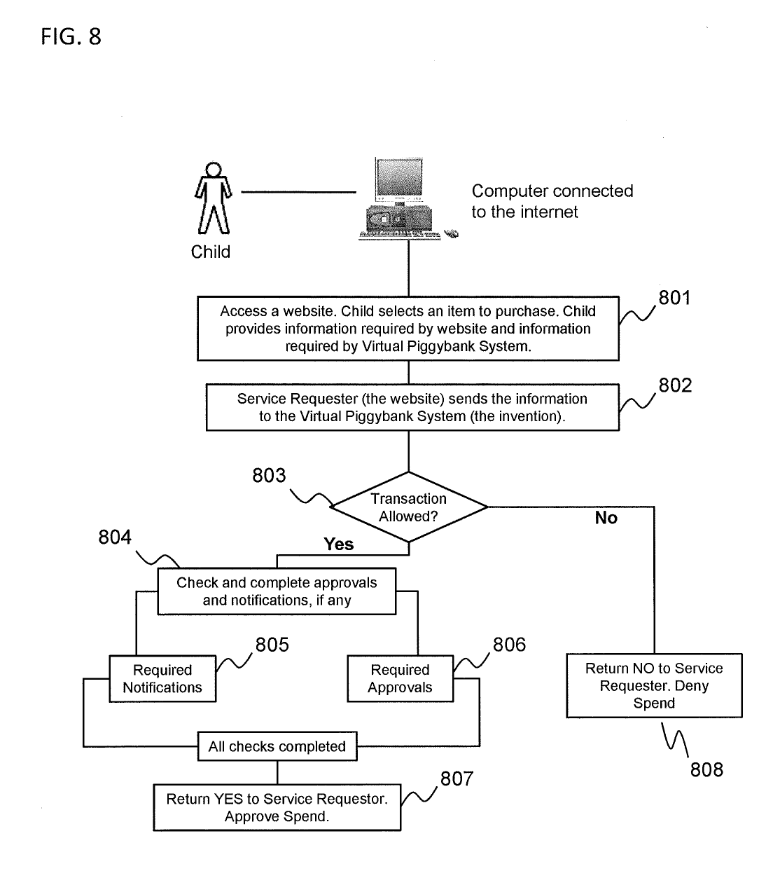

FIG. 8 is a flow chart illustrating a method for implementing the child spending functionality of virtual piggybank according to an exemplary embodiment of the present invention.

At step 801, a child accesses an Internet website and selects an item for purchase. Here, the virtual piggybank system may first determine whether a parent has allowed a child to access the website that the child is attempting to access. If a child is allowed to access the website, a child may then enjoy the website's content. Otherwise, a child may be redirected to an alternate website.

At step 802, the website (i.e., Service Requester) makes a request to the virtual piggybank system. The request package contains all the required information necessary to identify the child attempting to make a purchase to the virtual piggybank system plus all the information about the proposed transaction.

A service requester may establish a merchant account with the virtual piggybank system. The merchant account allows a service requester to provide information to the virtual piggybank system to contact the service requester. For example, the virtual piggybank system may support OpenID. A service requester may use their OpenID account to setup a merchant account. In addition, a service requester may establish a payment acceptance account. This account will be used to accept payment. For example, a service requester may use PayPal or a Google account linked with a bank account associated with the service requester. The virtual piggybank system may verify the validity of the account using the adaptive account API for Authentication.

At step 803, the virtual piggybank system examines the request. In particular, the request is checked against a child profile to determine whether a transaction is allowed or not. A child profile includes information necessary to determine whether a transaction is allowed. For example, a child profile may include a list of approved websites where a child is authorized to spend money from a child account, a spending limit limiting the amount of money that a child can spend without obtaining parental approval, or a periodic spending limit limiting the amount of money a child can spend per week or per month, or over any particular time limit. In addition, the virtual piggybank system also may allow a parent to specify a time period during which a child may spend money from a child account.

The virtual piggybank notifies the service requester whether the transaction is approved or not at steps 807 and 808, respectively. At the same time, if the transaction is approved, the virtual piggybank system may determine whether further approvals and/or notifications are required at step 804. If notifications are required, the required notification is sent to a parent or contributor, as appropriate, at step 805. Similarly, if a further approval is required, a seeking approval message is sent to a parent or contributor, as appropriate, at step 806. For example, an e-mail or SMS containing a seeking approval message may be sent to a parent or contributor. A parent or contributor may approve the pending transaction in a variety of ways such as reply SMS message, return e-mail, or by logging onto a parental or contributor account.

Thus, when a child logs onto the Internet and attempts to make a purchase at a Service Requester site that was previously designated as controlled by the virtual piggybank, the Service Requester bank makes a web service call to the virtual piggybank. The virtual piggybank exposes the preferences that were established by an adult, as described above, to the Service Requester. The preferences may be exposed to the service requester via an application programming interface through a web service, which may be a software system designed to support interoperable machine-to-machine interaction over the Internet.

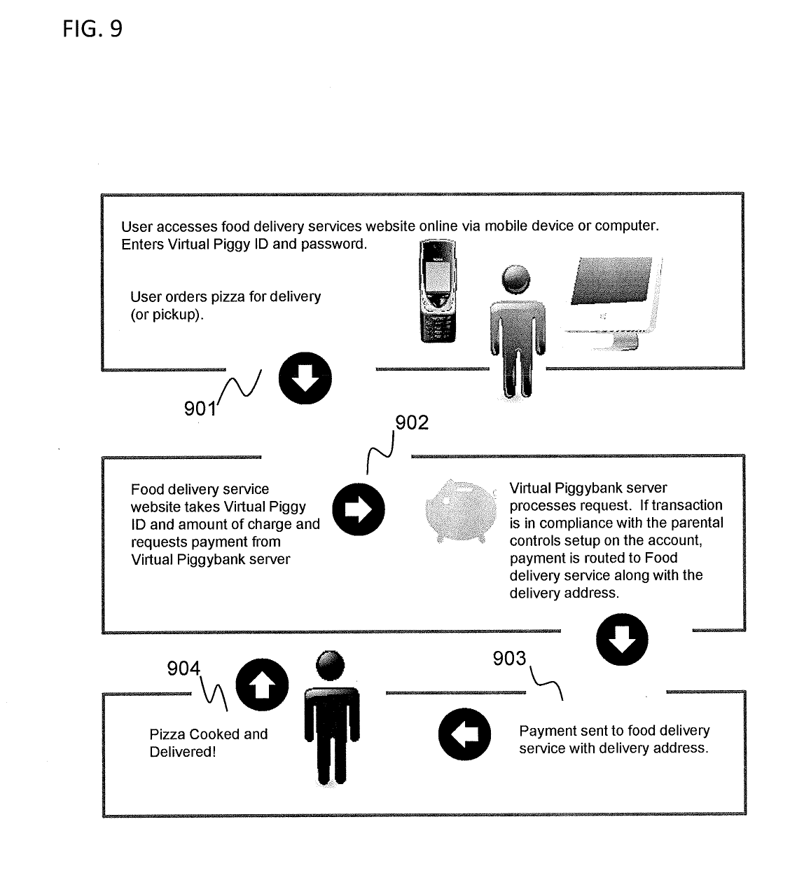

FIG. 9 illustrates an exemplary application of the virtual piggybank according to an exemplary embodiment of the present invention.

As shown in FIG. 9, a child user of a child account may access a service requester, such as a restaurant or food delivery system, at step 901. In this example, the service requester may obtain child account identifying information and present the child account information to the virtual piggybank system at step 902. Once the method for implementing the child spending functionality of virtual piggybank, as shown in FIG. 8, is performed and the service requester approved, a purchase from the service requester may be made. The virtual piggybank system then ensures that the service requester is paid for the selected service or item, at step 903. Accordingly, the service requester may then provide the purchased service or item, as shown in step 904.

As discussed above, a service requester may establish a merchant account with the virtual piggybank system. A merchant account allows a service requester to provide information to the virtual piggybank system to contact the service requester. For example, the virtual piggybank system may support OpenID. A service requester may use their OpenID account to setup a merchant account. In addition, a service requester may establish a payment acceptance account. This account will be used to accept payment. For example, a service requester may use PayPal or a Google account linked with a bank account associated with the service requester. The virtual piggybank system may verify the validity of the account using the adaptive account API for Authentication.

The virtual piggybank system may generate revenues by charging service requesters a fee per transaction. For example, the virtual piggybank system may use a payment account, such as a PayPal or Google account, as a payment network. The payment account may charge its standard rate (on average 2.9%+0.30 USD per transaction) in addition to the virtual piggybank rate.

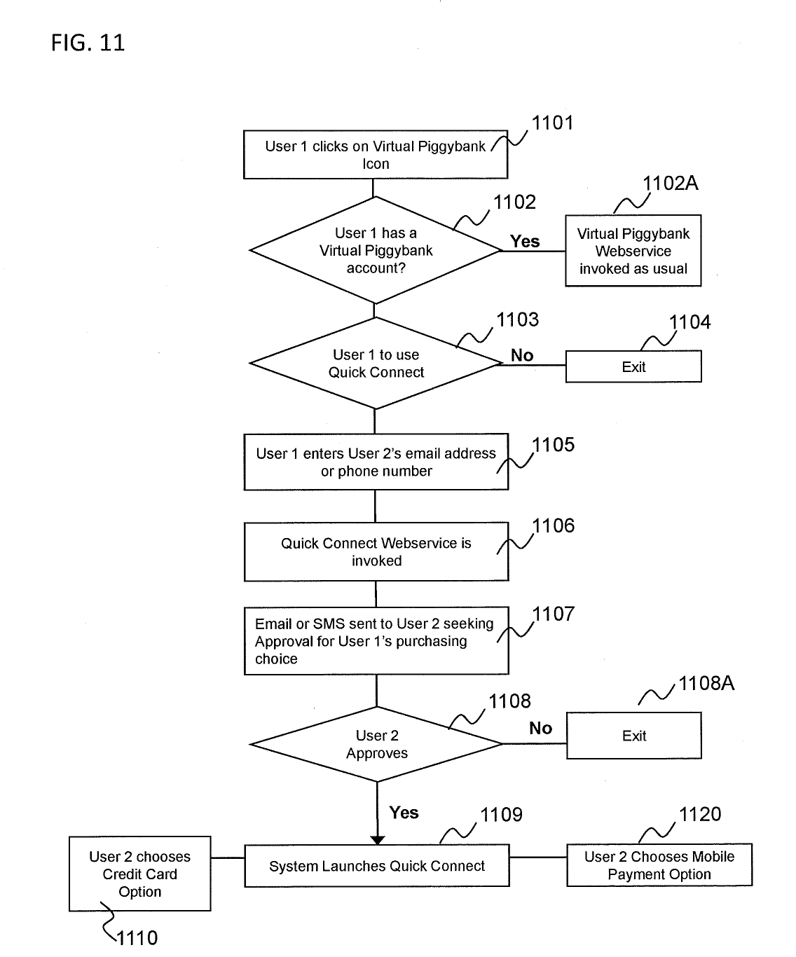

As shown in FIG. 11, the system provides a short-cut for sign up and use directly from a merchant's website by a child who may not already have an online account with the virtual piggybank system. For example, a child may select a product to purchase from a merchant's website that is partnered with the virtual piggybank system. In this case, the website will include an icon representing the online virtual piggybank system. The child may click on the icon at step 1101 of the inventive system to pay for the product. The child may indicate that there already is an established account with the virtual piggybank system at step 1102, and the requested purchase may be processed as discussed above (step 1102A). However, if the child does not already have an account with the virtual piggybank system a choice is made to either exit the virtual piggybank system (steps 1103 (indicating “no”) and 1104) or to have a parent establish the account (step 1103, indicating “yes”) through quick connect. If the child answers “yes” the virtual piggybank system sends a request for, and the child can enter, a parent's email address or telephone number at step 1105. Of course other ways to contact the parent will be known to those skilled in the art and are incorporated herein.

When the parent's contact information is input at step 1105, the virtual piggybank system's service is alerted at step 1106, which, in turn, sends the appropriate email, telephone text, etc. to the parent to obtain permission for the child's transaction at step 1107. The message to the parent may contain details of the transaction, including the merchant, product to be purchased, the price of the product, and any other information deemed germane and known to those skilled in the art. If the parent does not approve the transaction at step 1108, the transaction is terminated (step 1108A) and the parent exits the system. If the parent approves the transaction, by sending the appropriate type message, at step 1108, the virtual piggybank system begins to launch the quick connect feature for processing.

As shown in step 1109, the system launches the quick connect feature by sending a web page to the parent via the appropriate mobile device, or may send a link to a web page embedded in an email. Other methods of connecting the parent to the quick connect feature will be known to those skilled in the art and are incorporated herein. The quick connect web page enables the parent to create an immediate account for the child by using the parent's email address, telephone number, or other appropriate identifier known to those skilled the art. A random password may be created and sent to the parent. The web site also may contain all legal notices and an opt-out option and information relating thereto.

Once the immediate account is created, the virtual piggybank system inquires as to the type of payment the parent wishes to establish. The parent may choose a credit card at step 1110 or a mobile payment option at step 1120. Other types of payment options will be known to those skilled in the art and are incorporated herein.

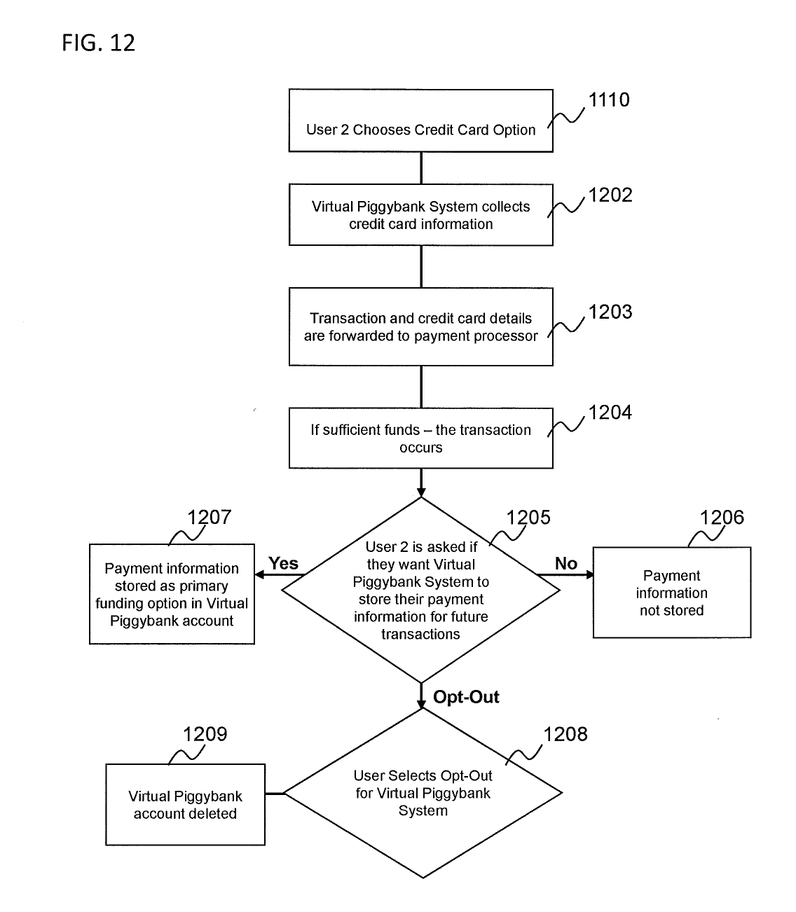

If the parent chooses to use a credit card as the payment option, the system requests the credit card information, as shown in FIG. 12, step 1202. The parent inputs the credit card information into a Payment Card Industry “PCI” compliant form, which is encrypted. The system then passes this transaction and credit card details to a payment processor at step 1203. The payment processor determines if the credit card information is valid and if sufficient funds are available for the particular requested purchase at step 1204. If the determination passes, the transaction is finalized. The virtual piggybank system notifies the parent that the purchase has been made and provides a receipt. The virtual piggybank system also notifies the parent of the user name and password that was created at step 1109, discussed earlier. The system further sends the parent a link to the virtual piggybank account that has been created. Step 1204.

At the conclusion of the quick connect transaction, the system may send an inquiry to the parent regarding future transactions at step 1205. For instance, the system may ask if the parent wants the virtual piggybank system to store the payment information that was used for the quick connect transaction for further use by the child. If the parent does not want the payment information stored, the virtual piggybank system automatically deletes the payment information and informs the parent of the deletion at step 1206. If the parent agrees to have the payment information stored, the virtual piggybank system stores the payment information at step 1207 with the virtual piggybank account that was created earlier. This payment information will be used as the primary funding for future transactions entered into by the child. All future transactions will be regulated as described earlier.

Another option that may be available to the parent at the end of the transaction is to opt-out of the virtual piggybank system altogether at step 1208. If the parent does not want a permanent account to be set up, the virtual piggybank system automatically deletes all information related to the quick connect account, and the parent is notified of the deletion at step 1209.

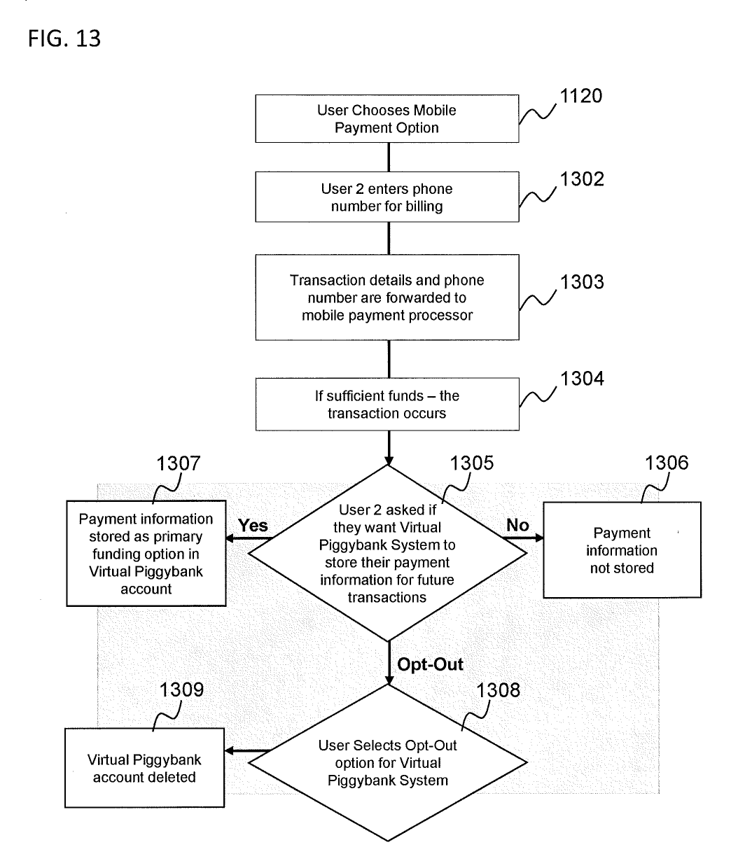

If the parent chooses to use a mobile payment option as the payment option at step 1120, the virtual piggybank system requests the mobile payment information, as shown in FIG. 13, step 1302. The parent inputs the appropriate telephone number; the virtual piggybank system notifies the parent through their mobile payment carrier about the charges and requests confirmation of the transaction at step 1302. The virtual piggybank system then passes this transaction and mobile device details to a mobile payment processor at step 1303. The payment processor determines if the mobile device information is valid and if sufficient funds are available for the particular requested purchase at step 1303. If the determination passes, the transaction is finalized. The virtual piggybank system notifies the parent that the purchase has been made and provides a receipt. The virtual piggybank system also notifies the parent of the user name and password that was created at step 1109, discussed earlier. The virtual piggybank system further sends the parent a link to the account that has been created at step 1304.

At the conclusion of the quick connect transaction, the virtual piggybank system may send an inquiry to the parent regarding future transactions at step 1305. For instance, the system may ask if the parent wants the system to store the payment information that was used for the quick connect transaction for further use by the child. If the parent does not want the payment information stored, the virtual piggybank system automatically deletes the payment information and informs the parent of the deletion at step 1306. If the parent agrees to have the payment information stored, the virtual piggybank system stores the payment information at step 1307 with the virtual piggybank account that was created earlier. This payment information will be used as the primary funding for future transactions entered into by the child. All future transactions will be regulated as described earlier. Another option that may be available to the parent at the end of the transaction is to opt-out of the virtual piggybank system altogether at step 1308. If the parent does not a permanent account to be set up, the virtual piggybank system automatically deletes all information related to the quick connect account, and the parent is notified of the deletion at step 1309.

It will be apparent to those skilled in the art that various modifications and variations can be made in the system and method for virtual piggybank of the present invention without departing from the spirit or scope of the invention. Thus, it is intended that the present invention cover the modifications and variations of this invention provided they come within the scope of the appended claims and their equivalents.

What is claimed is:

1. A computer-implemented method of establishing an online account for a prospective user, the method comprising the steps of:
presenting to a first user a merchant system through a network;
receiving from the first user a product selected from the merchant system for purchase;
presenting an online account icon for a banking system to the first user to initiate payment for the selected product;
once the icon is selected by the first user, determining if the user has an account with the banking system, and if not, prompting the first user to enter a second user's contact information;
contacting the second user by electronic messaging with a request to approve the first user's purchase; and
upon receiving the approval, creating the online account for the first user.

2. The computer-implemented method of claim 1, wherein the step of contacting the second user further comprises presenting to the second user a virtual bank via the network in order to set up the online account for the first user.

3. The computer-implemented method of claim 1, wherein the step of contacting the second user further comprises sending details of the requested purchase.

4. The computer implemented method of claim 3, wherein the details of the requested purchase includes identification of the merchant, a description of the product to be purchased, and a price of the product to be purchased.

5. The computer-implemented method of claim 1, wherein the second user's contact information is an email address.

6. The computer-implemented method of claim 1, wherein the electronic messaging used to contact the second user is an email.

7. The computer-implemented method of claim 1, wherein if the second user approves the requested purchase, sending a web page to the second user to create the online account using the second user's email address and a password.

8. The computer-implemented method of claim 1, further comprising presenting to the second user a choice of payment for the online account.

9. The computer-implemented method of claim 8, wherein the method of payment includes a credit card and credit card information is collected using a PCI compliant form.

10. The computer-implemented method of claim 9, wherein if sufficient funds are available for the requested purchase, a transaction occurs in the online account.

11. The computer-implemented method of claim 10, further comprising asking the second user whether the credit card information will be stored with the online account, or whether or not the online account should be deleted.

12. The computer-implemented method of claim 7, wherein the web page is sent to the second user's Internet activated device.

13. The computer-implemented method of claim 12, wherein the second user approves the online account through the second user's mobile device.

14. The computer-implemented method of claim 1, wherein the second user's contact information is a telephone number.

15. The computer-implemented method of claim 1, wherein the electronic messaging used to contact the second user is a text message.

16. The computer-implemented method of claim 1, wherein if the second user approves the requested purchase, sending a link to the second user's mobile device creating the online account using the second user's name and a password.

17. The computer-implemented method of claim 8, wherein the method of payment includes a mobile payment, and account information is collected and is sent to a mobile payment processor with the requested purchase information.

18. The computer-implemented method of claim 17, wherein if sufficient funds are available for the requested purchase, a transaction occurs in the online account.

19. The computer-implemented method of claim 12, wherein the second user's Internet activated device is cellular phone.

20. A system for establishing an online account for a prospective user, the system comprising:
a server connected to the Internet;
a client's Internet activated device;
a database hosted on the server, the database storing information for a money management system and for a virtual bank to facilitate payment to merchants over the Internet; and
web based systems, web services, and Internet enabled desktop applications partner with the virtual bank to create the online account for the first user.

21. A system according to claim 20, wherein the Internet activated device includes a mobile device.

22. A system according to claim 20, wherein the money management system includes controls on what web based systems may be accessed, how much money can be spent at the web based systems, how much money can be spent over a certain time period, who may contribute money to the online account, and who may receive notifications of the online account activity.

23. A system according to claim 20, wherein the virtual bank's online account may be initiated by a first user accessing a partner merchant's web based system, selecting a product for purchase, selecting a payment icon to initiate payment, and entering the second user's contact information when prompted.

24. A system according to claim 23, wherein the system sends details of a requested purchase at the partner merchant site to the second user including identification of the merchant's site, the product's description, and the product's price.

25. A system according to claim 24, wherein if the second user decides to approve the requested purchase, the system sends a web page to the second user's Internet activated device creating the online account using the second user's email address and a password.

26. A system according to claim 25, wherein if the chosen method of payment includes a credit card, credit card information is collected using a PCI compliant form processor and is sent to a payment processor with the requested purchase information.

27. A system according to claim 26, wherein if sufficient funds are available for the requested purchase, a transaction occurs in the online account.

28. A system according to claim 27, wherein the second user is prompted whether or not the credit card information will be stored with the online account, and whether or not the online account will be deleted.

29. A computer-readable storage medium, storing one or more programs configured for execution, the one or more programs for monitoring, transmitting, and recording usage of a computer or mobile device connected to a network, the one or more programs comprising instructions to:
presenting to a first user a partner merchant system through a network;
receiving from the first user a product selected from the partner merchant system for purchase;
presenting an online account icon for a banking system to the first user to initiate payment for the selected product;
once the icon is selected by the first user, determining if the user has an account with the banking system, and if not, prompting the first user to enter a second user's contact information;
contacting the second user by electronic messaging with a request to approve the first user's purchase; and
upon receiving the approval, creating the online account for the first user.
